(19) United States
(12) Patent Application Publication
(10) Pub. No.: US 2016/0371623 A1
(43) Pub. Date: Dec. 22, 2016

(54) PERSONALIZED RUN TIME KPI USING PROFILES

(71) Applicant: SAP SE, Walldorf (DE)

(72) Inventors: Vimal Sharma, Shimla (IN); Debasish Panda, Berhampur (IN)

(21) Appl. No.: 14/742,283

(22) Filed: Jun. 17, 2015

(51) Int. Cl. G06Q 10/06; G06F 17/30

(52) U.S. Cl. CPC G06Q 10/06393; G06F 17/30522

(57) ABSTRACT

A method, device, and system that relate to production and consumption of key performance indicators (KPI) in a networked system such that the KPIs are manipulated in Run Time by application of profiles. KPIs are created in a Design Time environment so that the KPI is generic and applicable to a plurality of different Run Time users. The generic KPI, once migrated to the Run Time environment, is subjected to at least one profile. A profile filters input KPI data according to specific criteria related to the Run Time User's personal and business roles in an organization. Profiles are automatically applied in the Run Time environment such that Run Time users, each having a profile, are exposed to only relevant data from the KPI. KPI data is cascaded from the generic KPI through a profile of the Run Time user.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyrights whatsoever.

### FIELD

A method, device, and system that relate to production of Key Performance Indicators (KPIs) in a KPI system and consumption of a modified set of KPI data in a Run Time environment by various Run Time users; and in addition, the invention relates to a Network server creating at least one profile that modifies the KPI data made available for consumption to various Run Time users.

### BACKGROUND

Key Performance Indicators (KPI), also sometimes known as Key Success Indicators (KSI) or Performance Indicators (PI), are quantifiable values that demonstrate whether and to what extent a target objective has been met. Typically, KPIs are implemented by organizations so that organizations can determine objectives specific to the organization and then evaluate a degree of success in meeting those objectives. KPIs can also be implemented to determine whether a specific activity or series of activities has been successful in meeting objectives.

Objectives identified by an organization as a target objective are sometimes called key business objectives. Key business objectives can be related to a variety of different industries, such as: Sales, Marketing, Financial, Manufacturing, IT Operations, Supply chain Management, Government, Insurance, Healthcare, Call Center, Social Media, and Business Intelligence. As an example, an objective can be one of: acquiring sufficient capital for a business related activity; reaching or maintaining a certain level of customer satisfaction with a product; expanding sales related to a specific product; and efficiently maintaining project performance. The objectives evaluated under a KPI are in some cases Business Metrics (BM). A KPI evaluates success as it relates to a single objective or multiple objectives at the same time.

KPIs are measured and evaluated over a time period, or up until a point in time when completion of a definable goal has been achieved. KPIs also can be used to measure completion of a series of definable goals. A time period for measuring a KPI can be short-term or long-term, and the time period can be singular or recurring. Generally, KPIs are traceable over time, such that the persons contributing towards the venture can gauge the success of the venture and make necessary changes to increase the likelihood of the success. KPIs may have inherent target values associated with the KPI to clearly indicate success.

KPIs are in some instances used to measure success of an entire entity but in other instances are used to measure the success of a sub-organization. KPIs can be used to objectively compare the success of multiple sub-organizations. KPIs can be monitored internally to an organization or externally by a competitor/interested investor. In some cases, potential investors request information related to a KPI in order to evaluate a potential investment. Accordingly, to track success rates for internal assessment purposes and for promotion to potential investors, organizations have an interest in tracking KPIs in different industries and projects.

To track KPIs, the KPIs must be created and configured by data analysts for the organization. To do so, the data analysts must individually create a KPI. Following creation, the data analyst must configure the KPI for a particular context and need of a user. Then, for each additional instance in which the KPI is to be used within an organization or sub-organization, the data analyst must both recreate and reconfigure the KPI—even if it is nearly identical to the original KPI. The process, therefore, becomes time consuming and redundant for the data analyst because the data analyst may have the same KPI used in different projects, in the same department, across different departments, and in different hierarchical levels of the organization, but still have to create and configure the KPI for each particular instantiation. The process is further complicated in that slight variations may be necessary for a KPI in different instances. For example, a sales monitoring KPI could be of interest to both a Sales Department and a Marketing Department, but with slight modifications to the KPI. To provide both the Sales Department and the Marketing Department with the KPI, the data analyst must begin anew with a KPI in both instances.

Such configuration and creation is performed by the data analyst in a Design Time environment, while the final KPI product reports on its objectives in Run Time and operates in a Run Time environment. Configuration of KPIs, including modification for small changes across a generic KPI is performed by filtering the KPI itself in the Design Time environment. Configuring in the Design Time environment is time and resource intensive. In addition, time spent in configuration reduces the amount of time that the KPI can be exposed to Run Time environment data. Moreover, the result of individual creation and configuration of numerous KPIs results in large pools of KPIs that are difficult to maintain, update, and organize.

### BRIEF DESCRIPTION OF THE DRAWINGS

FIG. 1 is an illustration of an environment 100 in which a KPI is instantiated.

FIG. 2 is an illustration of an environment 200 in which a KPI is configured or updated using a profile.

FIG. 3 is an illustration of a flowchart 300 for creating a new KPI.

FIG. 4 is an illustration of a flowchart 400 for configuring or updating a new KPI using a profile.

FIG. 5 is an illustration of a system 500 in which a KPI is created.

FIG. 6 is an illustration of an environment 600 in which a first generic KPI is created.

FIG. 7 is an illustration of a single filter 700, using a profile that is applied to a generic KPI.

FIG. 8 is an illustration of multiple filters collectively as filter 800, using a profile, being applied to a generic KPI.

FIG. 9 is an illustration of a system 900 in which a KPI is configured or updated according to a single tier profile filter structure.

FIG. 10 is an illustration of a system 1000 in which a KPI is configured or updated according to a multi-tiered structure having multiple applied filters.

FIG. 11 is an illustration of a system 1100 in which a KPI is configured or updated according to a multi-tiered structure having at least one user not assigned a profile.

FIG. 12 is an illustration of a system 1200 in which a central server creates and applies a profile based on data from other associated servers.

### DETAILED DESCRIPTION

Example embodiments of the present invention provide for a method, device, system, and computer program product for changing the production and consumption of KPIs for a group of Run Time users, otherwise known as C-level Users (CXOs). At least one generic KPI of interest for the Run Time users is created in a Design Time environment. The generic KPI is then, without manipulation for specific Run Time users, migrated into the Run Time environment. In the Run Time environment, each of the Run Time users has their respective user information associated with a profile, which is further described herein. In some embodiments, the profiles are referred to as unique analytical profiles (UAP). Accordingly, KPI data is cascaded through the profile of the Run Time user and thereby is filtered so that the Run Time user is only provided with contextual data relevant to a personal role and a business role of the Run Time user.

With implementation of the profiles, individualized production of numerous KPIs, each having a varying scope, is no longer necessary. Organization of the numerous KPIs is additionally no longer required provided that the number of initial KPIs created in Design Time is minimized. Instead, all restrictions related to privileges and scope can be automatically implemented and formulated during Run Time with profiles. By implementing the profiles in Run Time, the system additionally avoids stalls in the analysis of data that have previously resulted from restructuring of the KPIs in the Design Time environment.

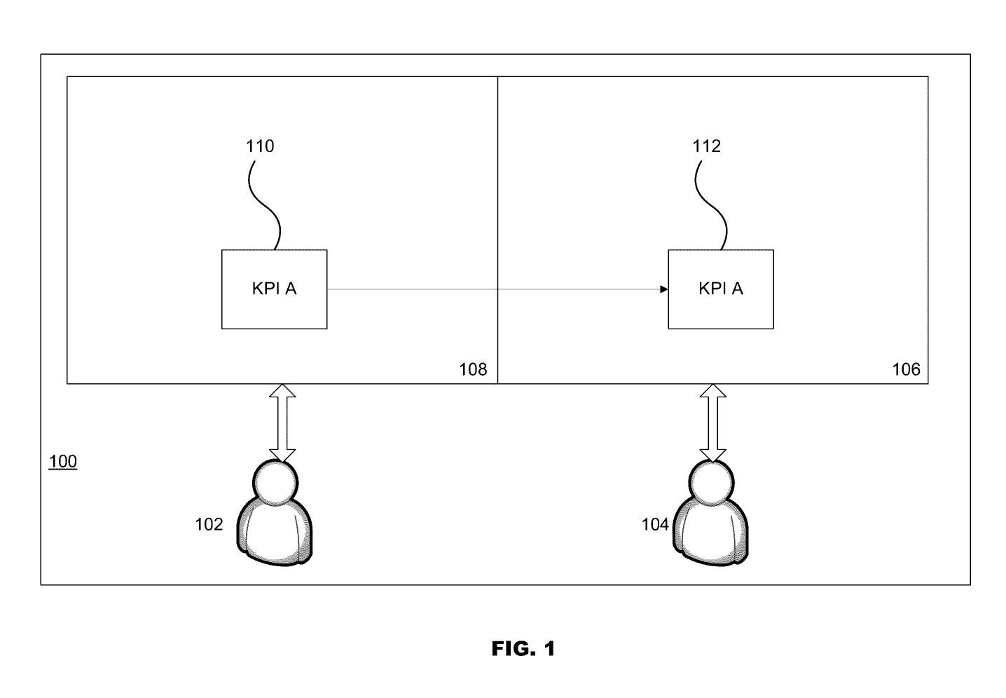

FIG. 1 is an illustration of an environment 100 in which a KPI is instantiated.

The life cycle of the KPI begins in Design Time environment 108 and ends in Run Time environment 106. A Developer, or Data Modeler, 102 creates KPIs in the Design Time environment 108. According to an example embodiment, Developer 102 creates KPI “A” 110 in the Design Time environment 108. Upon completion of creation, the Developer may test the KPI. The Developer may also simulate the KPI using simulation data. When the KPI “A” 110 has sufficiently passed all necessary tests, the Developer 102 migrates KPI “A” 110 into the Run Time environment 106 for use by the Run Time User 104. The KPI A available in the Run Time environment 106 is generic KPI A 112.

According to an example embodiment, more than one Developer is involved in the creation of the KPI. The KPI can also be made available to more than one Run Time User in the Run Time environment 106. KPI Developer 102 can create generic KPI A 110 according to needs of the Run Time user 104. KPI Developer 102 can create generic KPI A 110 according to instructions provided by an organization. The generic KPI A is created such that it is directed towards an objective and capable of evaluating a degree of success in meeting that particular objective. KPI A can also be created by the Developer 102 to determine whether an activity or multiple activities have resulted in, or been correlated with, a level of success in meeting an objective.

Generic KPI A 110 is, in an example embodiment, directed towards meeting a key business objective in a field such as: Sales, Marketing, Financial, Manufacturing, IT Operations, Supply chain Management, Government, Insurance, Healthcare, Call Center, Social Media, and Business Intelligence. Generic KPI A evaluates all criteria preset by the KPI Developer 102 by analysis of all linked data from servers associated with the Run Time environment. KPI A 110 can also be programmed by the Developer 102 such that it evaluates multiple objectives at the same time.

KPI A 110 is created by the Developer 102, with the understanding that KPI A 110 is a globally used, or generic, KPI. KPI A 110 is to be subjected to further filtering, and therefore, KPI A 110 includes information on a global or whole scale level. For example, a global KPI can provide evaluations of data in multiple languages, and as another example, global KPI reports on sales performance in multiple countries. According to an example embodiment, KPI A 110 is created in the Design Time environment 108. Developer 102, with awareness that additional processing will be performed on a case by case basis, creates KPI A 110 and does not invest time or additional resources into the configuration of KPI A in the Design Time environment.

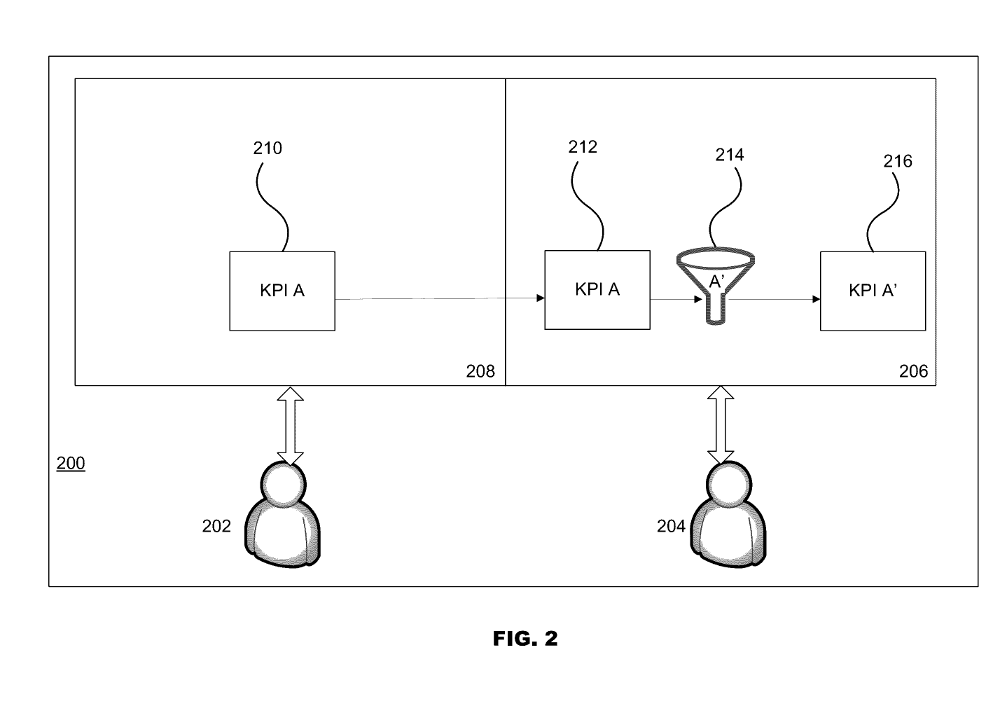

FIG. 2 is an illustration of an environment in which a KPI is configured or updated using a profile.

A profile 214 is a filter that is applied to a KPI in the Run Time environment 206. The profile 214 is a personalized filter set composed of two parts. A first part of a profile is a personal information component. A second part of a profile is business data component. According to an example embodiment, a profile 214 includes more than these two parts depending on the KPI application. As an example, an additional part of a profile would provide clearance level privileges to prevent non-authorized Run Time users from seeing confidential data related to the organization. The personal information component of the profile includes information related to the Run Time User 204 that is basic identifying information such as location, employee identification number, and languages spoken. The business data component of the profile includes information related to the Run Time User 204 specifically having to do with business information, such as projects and products of interest.

According to an example embodiment a Run Time user such as Run Time user 204 is unaware of the presence of the associated profile 214 or the contents of profile 214. Implementation of the profile is entirely invisible to the Run Time user.

Once the original generic KPI A 210 from the Design Time environment is made available in the Run Time environment as generic KPI A 212, the profile 214 is applied to the generic KPI A 212. Application of the profile to the KPI A 212 results in a modified KPI A′ 216, which is a specific implementation of the KPI made available to a particular Run Time User 204. The profile filter set includes data from across various systems and their respective databases. Specific information that is identified as filtering criteria in a profile can include: User, Role, User language, Data format, client information, user location (Country, City), user Organization, user Job profile, Product, product category, projects for which the user is responsible, and analytics privileges for the user. These various criteria, plus any other available identifiable criteria, are molded to form the profile filter set.

For example, a Run Time user 204 could have a profile 214 according to at least the following criteria. The criteria of the profile include the following fields: USER=id; ROLE=Sales Manager; COUNTRY=India; CITY=Bangalore; AP=SE Region; and PRODUCT CATEGORY=X,Y.

A profile for a user in one organization would differ from a profile of a user in a different organization due to their placement in different organizations, even if all other job related criteria were identical. Data to generate the profile for the user is provided from various systems and databases. For example, information integrated into the profile involving employee location, role, and responsibility is retrieved from a Human Capital Management (HCM) system and associated database. Information integrated into the profile involving projects specific to the user is retrieved from a project system and associated database. Specifically, the information retrieved from these systems and the associated databases is data in the form of objects. Object level privileges available to a user can vary, based on that specific user's Analytical Privileges. Accordingly, criteria related to Analytical Privileges are integrated into the profile. Analytical Privileges information is retrieved from a HANA Virtual Data Mart (VDM). Objects to be included in the profile are, in an example embodiment, pre-fetched and automatically assigned to the profile variant specific to a user.

Assigning the profile's creation is semi-automated. After a Run Time user is identified according to an identification number or an employee number, the profile filter set is created based on the data pulled from the different systems that are associated with that same identification number/employee number. As an example, one profile would include information from a first system that includes information about the Run Time User. Such information regarding the Run Time User could include data regarding the employee location, the employee role, and the employee responsibility. The data regarding the Run Time User could, in an example embodiment, be retrieved from a Human Capital Management System (HCM). The profile would also include information from a second system that includes information about a project and what projects are assigned to the Run Time user. This second system is physically distinct from the first system. In addition, the profile would also include information from a third system regarding the Analytical Privileges (AP) of the Run Time user. The third system, in an example embodiment, is an analytical privileges system in HANA VDM. The analytical privileges information retrieved from the AP system determines the specific Run Time user's level of access to restricted objects. The data retrieved from AP determines the end user's object level privileges. Upon having proper access, as defined by the profile, the objects can be pre-fetched and automatically assigned to the variant “filter set” according to the profile.

Data is uploaded into a profile automatically when a central server performs a system refresh. When a KPI is transferred into the Run Time environment, or when the KPI is called during Run Time, the profile is appended to the KPI. In the event that the KPI requires information not currently available to the profile, the profile requests, from the appropriate server, the required information. After initially uploading the information, the Developer can set a refresh rate. Upon a system refresh, profiles can be formed, and generic KPIs can be applied, or appended, to the formed profile. The formation and/or updating of the profile can occur at a system rate because the Developer's refresh rate cannot logically exceed the refresh rate of the system.

Profiles do not generally expire, and the information used to generate a profile determines the life cycle of the profile. Accordingly, a profile has a life cycle that is linked to life cycle of the data used in molding the profile. For example, an employee's employment data has a life cycle for the term of the employee's employment. Upon the expiration or termination of employment, the profile will be deemed to have expired.

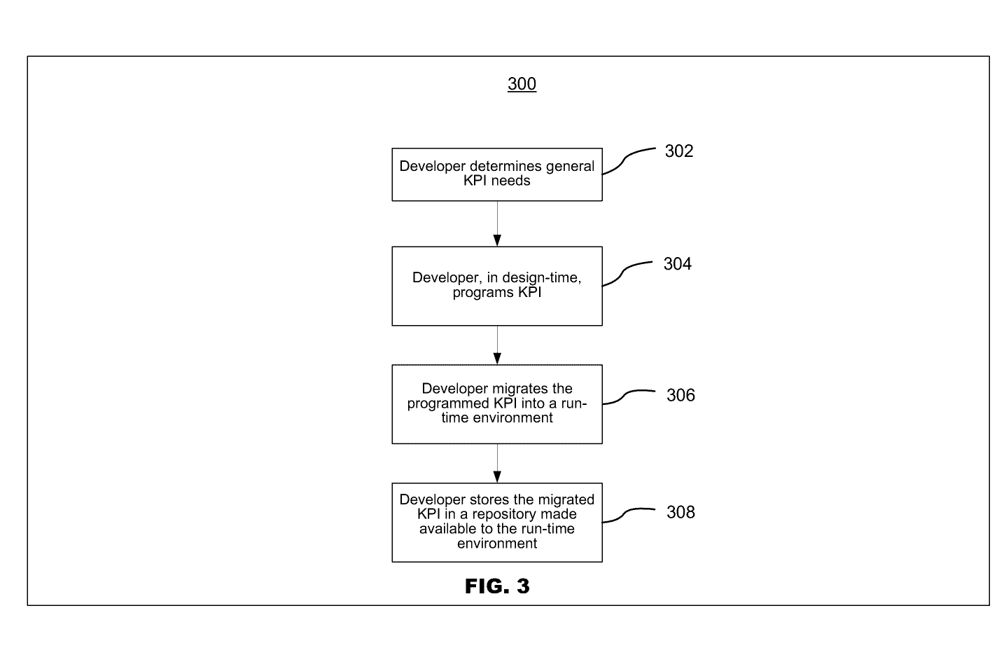

FIG. 3 is an illustration of a flowchart for creating a new KPI.

At 302, the Developer determines a KPI is necessary and the objectives to which the KPI should be directed.

At 304, the Developer, in the Design Time environment, programs the generic KPI.

According to an example embodiment, following the programming of the generic KPI, the Developer tests the programmed KPI. The programmed KPI can also be simulated by the Developer using simulation data in a simulation environment.

At 306, the Developer, following successful testing of the KPI migrates the generic KPI to a Run Time environment for use by at least one Run Time user.

At 308, the Developer stores the migrated KPI in a database made available to the Run Time environment. The database, according to an example embodiment, is a KPI Repository that stores a plurality of KPIs for the organization.

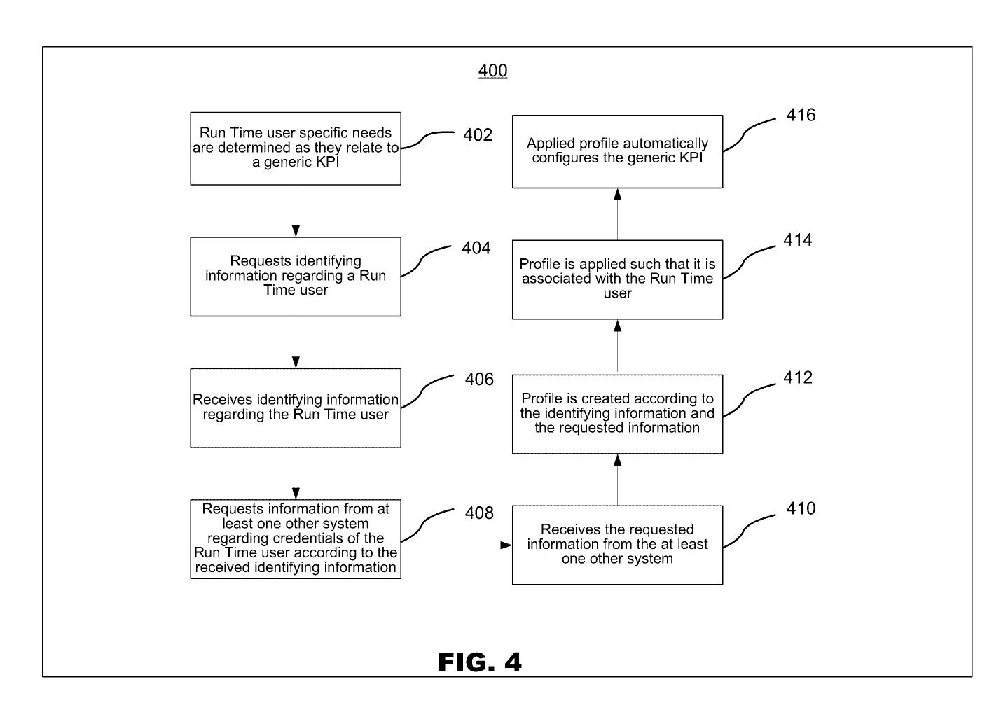

FIG. 4 is an illustration of a flowchart for configuring or updating a new KPI using a profile.

At 402, the Developer determines specific needs of a Run Time user as they relate to a generic KPI. According to an example embodiment, the specific needs involve receipt of a distinct data set. The distinct data set may be made available to a Run Time user specifically based on the Run Time user's credentials. The Developer selects a generic KPI stored in a repository that will be modified by a profile in order to suit the Run Time user's needs.

At 404, a central server requests identifying information from the Run Time user. A request for identifying information from the Run Time user can be provided directly to the user or a system server associated with the central server. The central server request can specifically identify the criteria desired for further analysis or the central server can request generally all identifying information regarding the Run Time user. In an example embodiment, the minimum information requested by the central server includes an employee identification number.

At 406, the central server receives identifying information from the Run Time user.

According to an example embodiment, the central server receives identifying information directly from the Run Time user. The identifying information could instead be received from a system server associated with the central server. In another example embodiment, both the Run Time user and the system server provide the identifying information. The system server, or a database associated with the system server, hosts information related to the Run Time user. Information hosted in the system server could include an employee identification number, an employee name, employee location, and a user name. According to an example embodiment, a system server associated with the central server sends the identifying information to the central server. Alternatively, the central server fetches the identifying information from the system server. The system server hosting identifying information regarding the Run Time user is in an example embodiment a Human Capital Management system (HCM). The identifying information received from the Run Time user and/or the system server is in the form of objects. For example, the identifying information includes personal data objects for the Run Time user.

At 408, the central server requests information from at least one independent data-hosting system regarding other credentials of the Run Time user according to the received identifying information. The central server request can specifically identify the information desired for further analysis. The central server can also formulate the request generally to include all information from the data-hosting system that is related to the identifying information. According to an example embodiment, the request includes a reference to the employee identification number of the Run Time user.

At 410, the central server receives from at least one independent data hosting system the requested information regarding the Run Time user. According to an example embodiment, the central server receives the requested information from the at least one independent data hosting system. The at least one independent data hosting system can be more than one of the same type of system or several systems of different types. According to an example embodiment, the at least one independent data hosting system includes at least one of an Analytical Privileges (AP) system, a Project Responsibilities system, a HCM system, a Business Intelligence (BI) system, Customer Relationship Management (CRM) system, or a Virtual Data Mart (VDM) system. Information hosted on these systems could include information such as: projects, responsibilities for projects, project hierarchy, products, sales for products, analytical privileges, and other pertinent information necessary for filtering the KPI. According to an example embodiment, one of these independent data hosting systems sends the requested information to the central server. Alternatively, the central server fetches the requested information from the data hosting system. If the central server fetches the requested information from the data hosting system, the central server may be required to provide authentication on behalf of the Run Time user. The requested information received is in the form of objects. For example, the requested information from a Project Responsibilities system includes objects related to the projects with which the Run Time user is involved.

At 412, the central server creates a profile for the Run Time user according to the: 1) identifying information and 2) the requested information regarding the Run Time user. The central server has a processing device that molds the identifying information and the received requested information into a profile for the Run Time user. Creation of the profile is automatic on the system. The central server performs the data requests and compilations for each Run Time user. In an example embodiment, the objects necessary for creation of a profile are pre-fetched by the central server and are automatically assigned to a profile.

At 414, the central server applies the profile in the Run Time environment so that the profile is associated with the Run Time user. The profile, once created, is automatically assigned to the Run Time user. According to an example embodiment, the profile is assigned to a group of people, such as a department, an organization, or a group of people having a same job description/title. According to an example embodiment, a profile is assigned to a task and all of the Run Time users associated with the performance of the task. The profile can be included in a dashboard filter, including a plurality of profiles for different Run Time users, where the dashboard filter properly applies the appropriate profile for each of the Run Time users.

At 416, the applied profile automatically configures the KPI. The profile is applied such that data is cascaded through the generic KPI and then through the profile for the specific Run Time user.

According to an example embodiment, a profile can be created and assigned to a Run Time user prior to the creation and migration of a KPI. Creation and assignment of a profile can also be performed during the creation and migration of KPI. A profile can also be created and assigned following the creation and migration of a KPI. All profiles on the system need not be created and assigned at the same time. Different Run Time users can be assigned to a respective profile at different times. In an example embodiment, responsive to a new user's information being entered into a KPI system, a profile for the new Run Time user is automatically generated and assigned to the Run Time user.

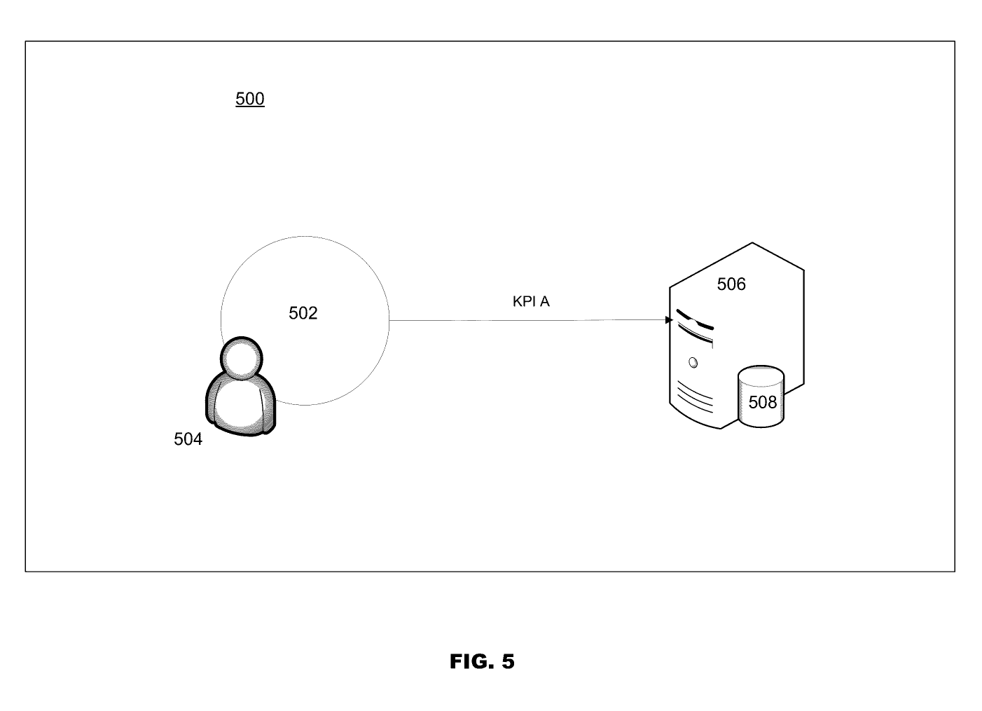

FIG. 5 is an illustration of a system 500 in which a generic KPI is created. The system 500 includes a local device, at which the Developer 504 creates a generic KPI in a Design Time environment 502. The local device at which the Developer 504 interacts with the Design Time environment 502 can be a terminal, a personal computer, a laptop, and other similar computing platforms. In an example embodiment, the Developer 504 creates generic KPI A in the Design Time environment 502. After completion of the creation of generic KPI A, the Developer migrates the completed generic KPI A to a server 506. Server 506 has an associated database 508.

After migration of the completed KPI A to the server, the generic KPI is pushed to and saved in the database 508. According to an example embodiment, the database 508 is a repository of generic KPIs created by the Developer 504. In another example embodiment, the database 508 is a repository of generic KPIs created by a plurality of Developers, each having access to the database 508.

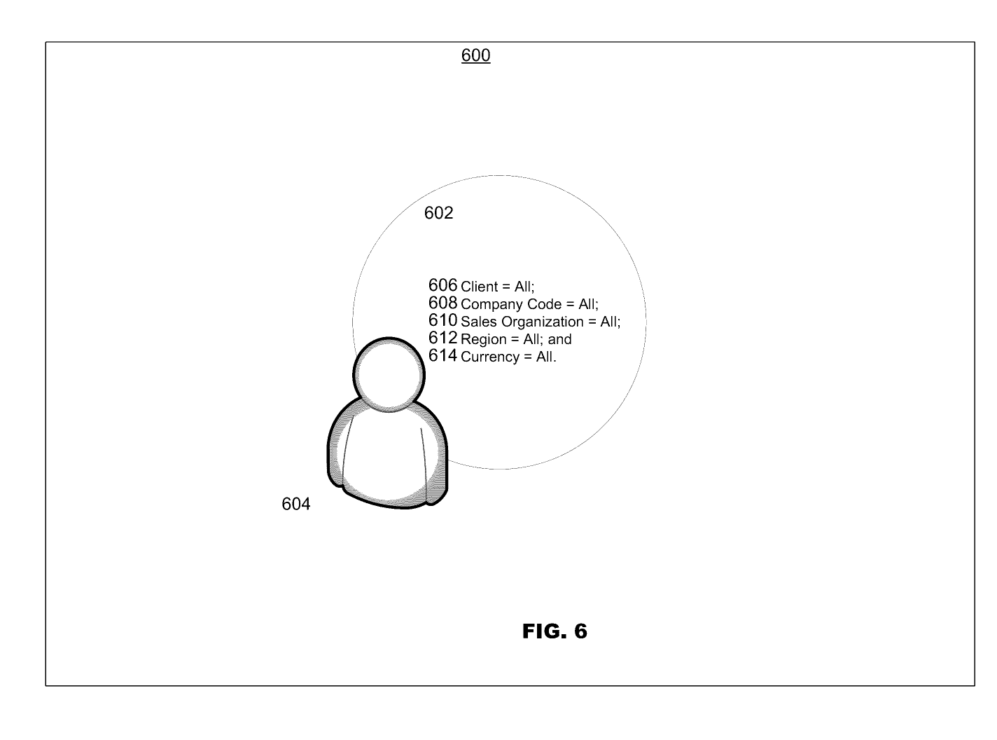

FIG. 6 is an illustration of an environment 600 in which a first generic KPI is created.

A generic KPI 602 is created in the Run Time environment by the Developer 604. As described above, the generic KPI includes a variety of different fields for filtering criteria. According to an example embodiment, the fields of generic KPI can include: Client 606; Company Code 608; Sales Organization 610; Region 612; and Currency 614. Developer 604, by setting these criteria, can include data in the KPI that is available to all client pools (Client =All), all companies (Company Code=All), all sales organizations (Sales Organization=All), all regions (Region=All), and all currencies (Currency=All). Accordingly, the generic KPI has at least one field for filtering criteria, and that at least one field includes an “ALL” entry.

For example, a Run Time User A working on a project for particular Client A, within Company Code A, dealing with Sales Organization A, in the Northeast Region, and dealing with US currency would have this KPI applied as a generic KPI. The same generic KPI would be applied to a Run Time User B working on a project for particular Client B, within Company Code B, dealing with Sales Organization B, in the Midwest region, and dealing with the Euro as currency.

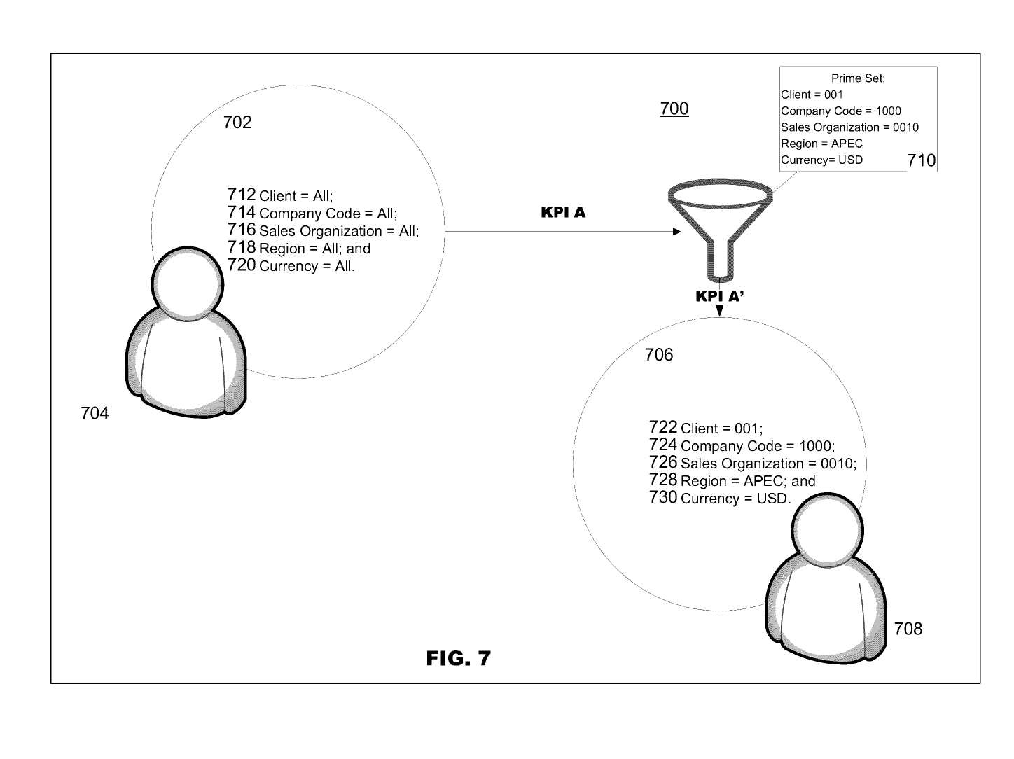

FIG. 7 is an illustration of a single filter, using a profile, that is applied to a generic KPI.

According to an example embodiment, profile Prime 710 is applied to a generic KPI. Developer 704 creates a generic KPI A in a Design Time environment 702. The generic KPI A is developed as having several different fields. Generic KPI A Fields include Client 712, Company Code 714, Sales Organization 716, Region 718, and Currency 720. For the generic KPI A, none of these fields are limiting, and each has the filtering criteria set to “ALL.” Each field is set such that no limitations or filtering is performed. The generic KPI, upon completion, is saved in a KPI repository. Thereafter, the KPI is made available to all parties upon activation of the KPI in the Run Time environment.

Once activated, the generic KPI A is applied to different profile Filters, such as the profile Prime filter 710. The profile Prime filter 710 serves at least dual purposes.

First, profile Prime filter 710 can be implemented to determine the applicability of the generic KPI A to the user associated with the profile 710, Run Time user 708.

If the generic KPI is deemed not applicable to the user, then KPI A is not applied to the profile associated with the user. No data originally made present in the generic KPI A flows to the Run Time user 708. For example, if generic KPI A provides analysis of meeting Business Objective C, and if Run Time user 708 only deals with meeting Business Objectives A & B, then generic KPI is not applicable to the Run Time user.

If the generic KPI is deemed applicable to Run Time user 708, then the data made available in generic KPI A is filtered through the Prime Filter set 710. Prime Filter set 710 allows information only available to Client 001, Company Code 1000, Sales Organization 0010, the APEC Region, and USD Currency to pass to the Run Time User 708. For example, if generic KPI A provides analysis of meeting Business Objective A, and if Run Time user 708 only deals with meeting Business Objectives A and B, then generic KPI A is applicable and will be applied to the profile.

Second, profile Prime filter 710 provides only useful information, calculations, and information related to the objectives of Run Time User 708.

For example, if generic KPI A provides analysis of meeting Business Objective A in the APEC Region and the NAFTA Region, and if Run Time user 708 only deals with meeting Business Objective A in the APEC Region, then generic KPI A is applicable. However, further, only information related to meeting Business Objective A in the APEC Region will be provided to Run Time user 708. Information related to meeting Business Objective A in the NAFTA region will not be provided to Run Time user 708.

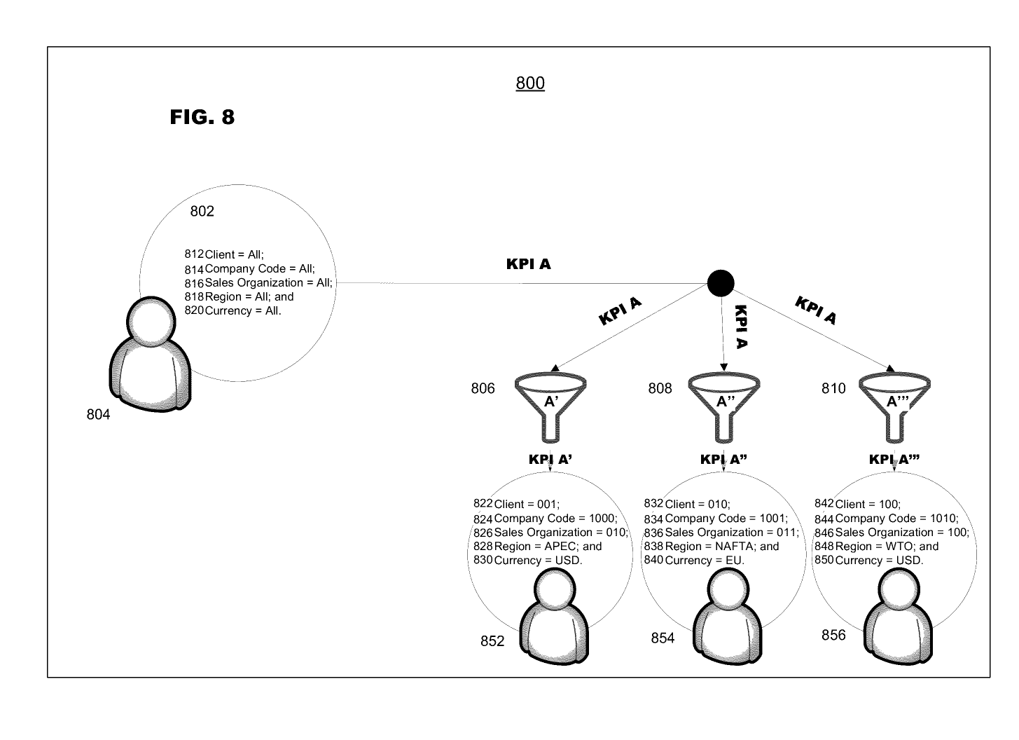

FIG. 8 is an illustration of multiple filters collectively as filter 800, using a profile, being applied to a generic KPI.

According to an example embodiment, multiple profiles are applied to a generic KPI, with different of the multiple profiles being applied for different Run Time Users. For example, each of Run Time Users 852, 854, and 856 have an interest in evaluating an objective in a different manner. Run Time Users 852, 854, and 856 are interested in evaluating the KPI according to a different criteria. For instance, Run Time User 852 is interested in the application of generic KPI A to client 001, whereas Run Time User 854 is interested in the application of generic KPI to client 010.

In order to adjust the KPI for each of the individual Run Time users' needs, more than one profile is applied. In an example embodiment, each of the Run Time Users 852, 854, and 856 have a respective profile: A′ (806), A″ (808), and A′″ (810). Generic KPI A is designed in Design Time environment 802 by Developer 804. Generic KPI includes fields for at least Clients 812, Company Codes 814, Sales Organizations 816, Regions 818, and Currencies 820. After the generic KPI A is saved to a KPI repository and migrated to Run Time, profile filters are applied for each of the Run Time Users.

By applying profile filter 806 A′, Run Time User 852 has access to KPI A′. KPI A′ includes the functionality of the generic KPI A, but it reports information specific to the criteria set in the profile for A′ including: Client 822=001; Company Code 824=1000; Sales Organization 826=010; Region 828=APEC; and Currency 830=USD.

By applying profile filter 808 A″, Run Time User 854 has access to KPI A″. KPI A″ includes the functionality of the generic KPI A, but it reports information specific to the criteria set in the profile for A″ including: Client 832=010; Company Code 834=1001; Sales Organization 836=011; Region 838=NAFTA; and Currency 840=EU.

By applying profile filter 810 A′″, Run Time User 856 has access to KPI A′″. KPI A′″ includes the functionality of the generic KPI A, but it reports information specific to the criteria set in the profile for A′″ including: Client 842=100; Company Code 844=1010; Sales Organization 846=100; Region 848=WTO; and Currency 850=USD.

Each of KPI A′, KPI A″, and KPI A′″ are active in the Run Time environment and provide Run Time KPI reporting to the respective users of the profile.

In an example embodiment, different profiles include some but not all of the same criteria. According to an example embodiment, different profiles can include the same criteria, except for an employee identification number, but be separate from one another, (e.g., A′ and A*) in order to provide for easier modification for a specific set of users at a later time.

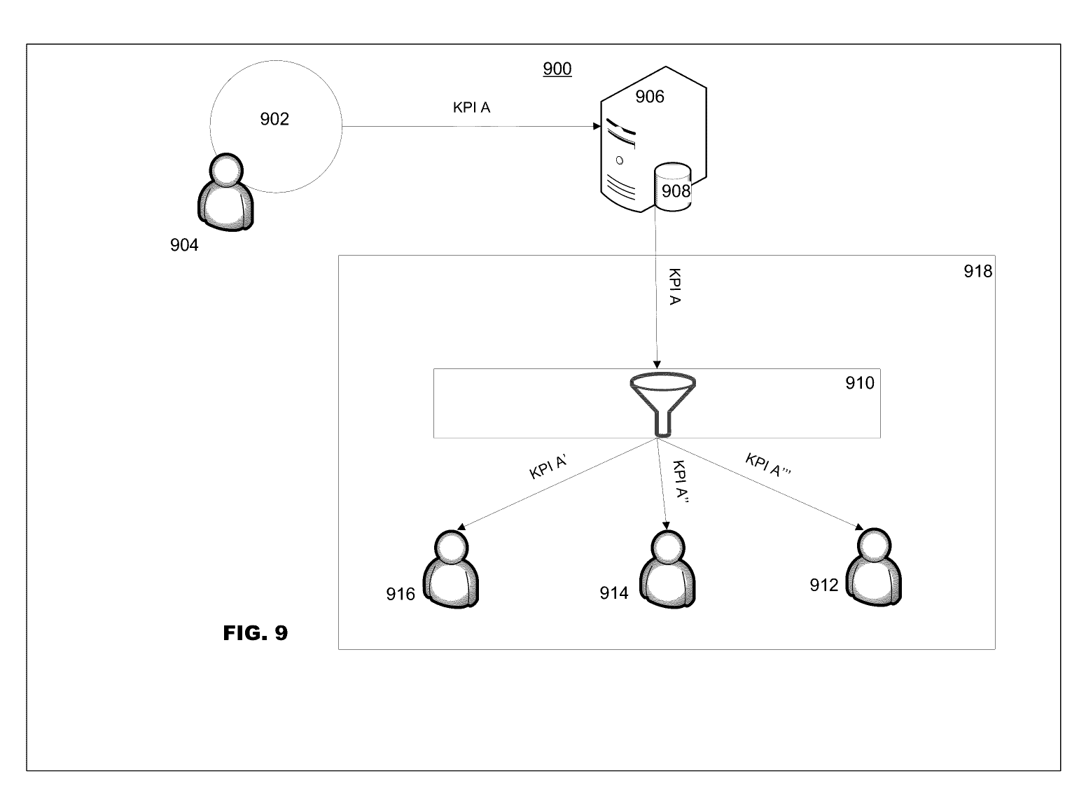

FIG. 9 is an illustration of a system 900 in which a KPI is configured or updated according to a single tier profile filter structure.

In system 900, a single filter layer 910 is applied that provides the necessary profiles to each of the Run Time users. Application solely of the single filter layer means that, for each Run Time user, only one profile is available. Single filter layer 910 can be implemented as a dashboard so that the single filter layer 910 can apply more than one profile to a KPI, with one profile for each of the Run Time users. Implementation of the single filter layer 910 as the dashboard can also be set up such that more than one KPI is accepted as an input to the single filter layer 910. Accordingly, a single filter layer 910 can accept as an input 1 to N number of KPIs where there are N KPIs available via the server 906 and the KPI repository 908. The single filter layer 910 can provide output as a modified KPI for 1 to M number of Run Time users where there are M Run Time Users in the system 900. For each of the Run Time users, a profile is applied. The single filter layer 910 includes P profiles, where P=M. A profile associated with a Run Time User can be applied concurrently to more than one KPI, for instance N KPIs, for the same Run Time User.

In the dashboard implementation of the single filter layer 910 includes additional filters that are not profiles. For example, a Filter layer 910 is made available for different Run Time Users such as Users 912, 914, and 916. For one of the Run Time Users, 916, the single filter layer 910 includes the profile associated with Run Time User 916. However, for other Run Time User 914, the single filter layer includes the profile associated with Run Time User 914 as well as at least one additional filter. The at least one additional filter provides functionality in order to support the KPI applied, KPI A. The at least one additional filter is, in an example embodiment, is implemented in order to handle a temporary or adhoc issue that presents from running the KPI A. When the Run Time Users open the dashboard, the KPI, e.g., KPI A, requests application of the single filter layer 910, which includes the at least one additional filter layer and the necessary profiles.

Run Time Users 912, 914, and 916 each receive a KPI that is modified to respond to criteria from a profile. Developer 904, in the Design Time environment 902, created a KPI A that was sent to server 906 and stored in associated database 908. According to an example embodiment, database 908 is a KPI repository available to all or some of the Developers on the system 900. The original KPI A was inserted into the Run Time environment 918 from the KPI repository 908.

Each of the Run Time users 912, 914, and 916 has a single profile, and therefore, the KPI A is applied to three profiles, one for each of the users. Accordingly, Run Time User 916 has received through single filter layer 910 a modified KPI A′. Run Time User 914 has received through single filter layer 910 a modified KPI A″. Run Time User 912 has received through single filter layer 910 a modified KPI A′″.

According to an example embodiment, each of the Run Time users 912, 914, and 916 has access the KPI related information (KPI A′″, KPI A″, and KPI A′, respectively) through a respective user interface. A user interface can be software, a plug-in, or an application run on one of: a cellular phone, a personal computer, a tablet, a laptop, a PDA, and other portable electronic devices. A user interface can also be structured in an Internet browser such that a webpage, website, or portal page on the Internet/an Intranet provides access to the KPI related information for the respective Run Time user. A Run Time user may need to provide authorization credentials to access the data made available through the KPI software. Through a respective user interface, each of the Run Time Users can manipulate the data made available to them through the cascade of the KPI and a profile.

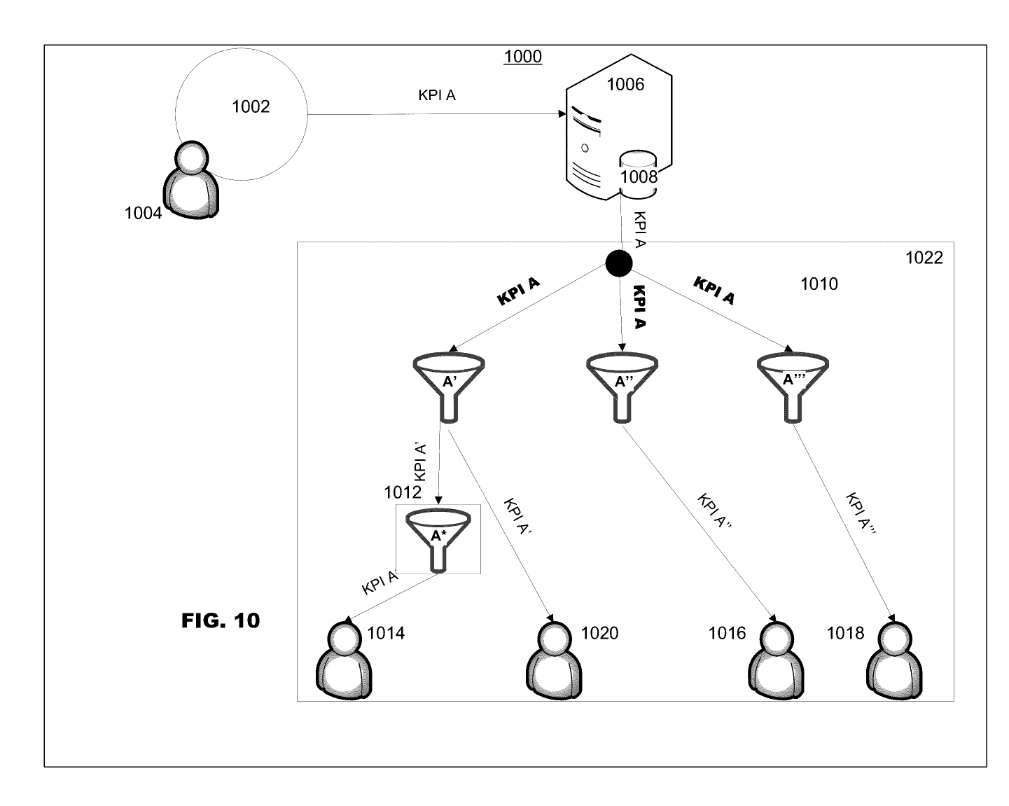

FIG. 10 is an illustration of a system 1000 in which a KPI is configured or updated according to a multi-tiered structure having multiple applied filters.

In system 1000, a first set of filters 1010 is applied for each of the Run Time Users. Run Time Users 1014, 1016, 1018, and 1020 each receive a KPI that is modified to respond to criteria from a respective profile. Developer 1004, in the Design Time environment 1002, created a KPI A that was sent to server 1006 and stored in associated database 1008. According to an example embodiment, database 1008 is a KPI repository available to all or some of the Developers on the system 1000. The original KPI A was inserted into the Run Time environment 1022 from the KPI repository 1008.

Each of the users 1014, 1016, 1018, and 1020 has the KPI exposed to a first profile. Accordingly, Run Time User 1018 has received through a respective filter from the first set of filters 1010 a modified KPI A′″. Run Time User 1016 has received through a respective filter from the first set of filters 1010 a modified KPI A″. Run Time User 1020 has received through a respective filter from the first set of filters 1010 a modified KPI A′. However, Run Time User 1014 receives a modified KPI A* which is subjected to both a respective filter from the first set of filters 1010 and also an additional filter 1012. As an example, Run Time User 1014 and Run Time User 1020 can have nearly identical profile criteria. Initially both Run Time Users 1014 and 1020 had the following criteria: Client: 0100; Company Code: 010; Sales organization: 1000; Region: NAFTA; and Currency: USD. However, at a later date, Run Time User 1014 was instructed to apply the KPI to a recently acquired subsidiary of the organization, with a different company code. In such a situation, the Run Time User 1014 interacts with the server to personalize his own profile. In this particular instance, Run Time User 1014 modifies his profile by creation of additional filter 1012. Accordingly, now Run Time User 1014 has the following criteria: Client: 0100; Company Code: 010; Subsidiary Code: 001; Sales organization: 1000; Region: NAFTA; and Currency: USD.

To provide user 1014 with the appropriate overall filter, one of the filters from the first set of filters 1010 is cascaded with additional filter 1012.

According to an example embodiment, more than two filters can be cascaded in order to provide an applicable profile for a single Run Time environment. More than one user in the Run Time environment may have multiple cascaded filters at one time.

Instead of cascading two filters, a profile can also be modified. Modification of a profile can be performed upon a change of the underlying data associated with the respective Run Time user, upon a prompt initiated by the Run Time user, or upon a prompt initiated by the Developer. When the profile is modified, the entire profile does not need to be rewritten and reinstituted. The profile is modified by performing a delta modification so that only the aspects of the profile necessary to be changed for the modification are changed.

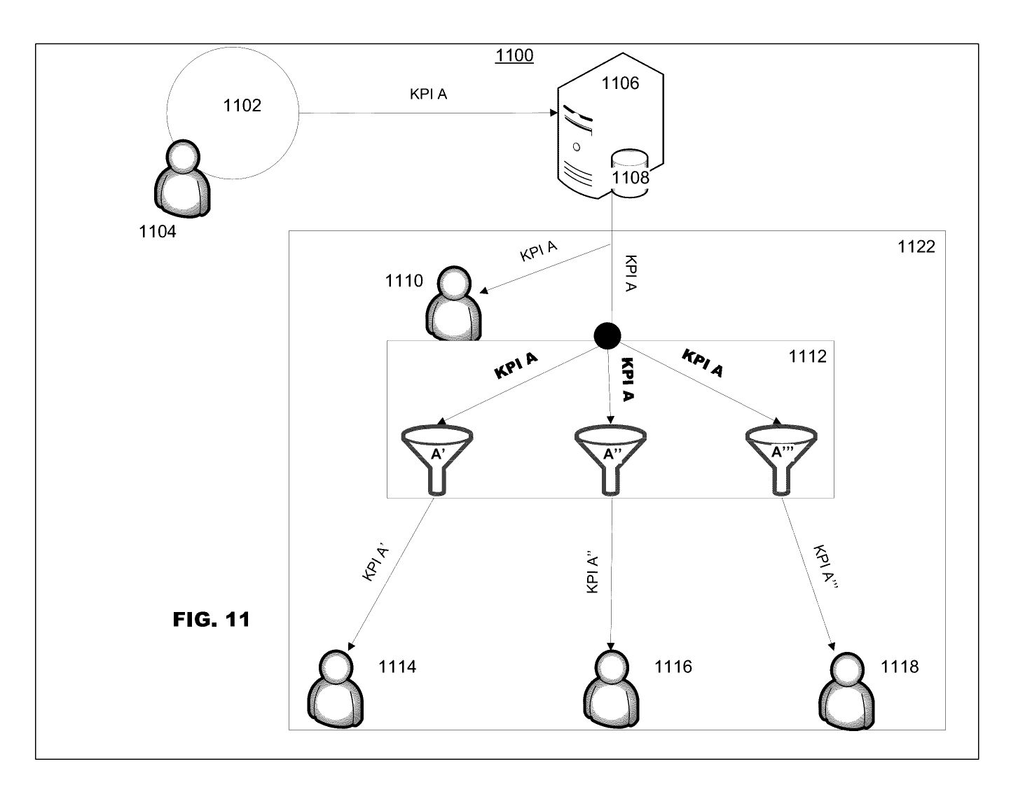

FIG. 11 is an illustration of a system 1100 in which a KPI is configured or updated according to a multi-tiered structure having at least one user not assigned a profile.

In system 1100, a set of filters 1112 is applied for some of the Run Time users. Run Time users 1114, 1116, and 1118 each receive a KPI that is modified to respond to criteria from a respective profile. Developer 1104, in the Design Time environment 1102, created a KPI A that was sent to server 1106 and stored in associated database 1108. According to an example embodiment, database 1108 is a KPI repository available to all or some of the Developers on the system 1100. The original KPI A was inserted into the Run Time environment 1112 from the KPI repository 1108.

In this system 1100, at least one Run Time User does not have a profile applied to the generic KPI A. Specifically system 1100 provides an example in which Run Time user 1110 directly receives KPI A. According to an example embodiment, Run Time User 1110 is a CEO. According to an example embodiment, Run Time User 1110 is a system administrator. Overall, a Run Time User receiving the KPI without application of a profile could have an interest in viewing the KPI applied to each and every aspect of the business, regardless of possible filters. Run Time User is, in some embodiments, a user having a high privilege level to receive the mass of information available from the unfiltered data analysis.

In the same embodiment, each of the users 1114, 1116, and 1118, however, has had their KPI exposed to a profile. Accordingly, Run Time User 1118 has received through a filter from set of filters 1112 a modified KPI A′″. Run Time User 1116 has received through a filter from set of filters 1112 a modified KPI A″. Run Time User 1114 has received through a filter from set of filters 1112 a modified KPI A′.

FIG. 12 is an illustration of a system 1200 in which a central server creates and applies a profile based on data from other associated servers.

KPI A, having been migrated to the Run Time environment, is transmitted to central server 1208 and the associated KPI repository 1206. Central server 1208 is further responsible for requesting: 1) identifying information from a system server that hosts information related to the Run Time user and 2) additional information related to the Run Time user. In so doing, the Central Server 1208 may request, or query, for this data from one of the associated system servers 1220 and 1224. Although two associated system servers are shown in this example embodiment, any number of associated system servers may be implemented and networked with the central server 1208.

Each of the system servers 1220 and 1224 has a respective database 1222 and 1226. Servers 1220 and 1224 can be any associated server such as: of an Analytical Privileges (AP) system, a Project Responsibilities system, a HCM system, a Business Intelligence (BI) system, Customer Relationship Management (CRM) system, or a Virtual Data Mart (VDM) system. Other system servers having data relevant to a KPI determination, not explicitly listed here, could be included as well. Central server 1208 uses information collected from these servers and/or the Run Time user 1214 and creates a profile 1212 associated with Run Time user 1214 in the Run Time environment 1210. Information collected from the servers 1220 and 1224 can include any criteria that may be used to narrow the scope of the KPI for the Run Time user 1214 such as: employee location, responsibilities for projects, and analytical privileges.

Multiple KPIs can be applicable to one Run Time user. A Run Time user can, in an example embodiment, select which of a plurality of KPIs are of interest to the Run Time user and should be applied to the Run Time user. The KPIs available to the Run Time user can be pre-set. If the KPIs available to the Run Time user are pre-set, the Run Time user may or may not be able to un-enroll or unsubscribe to data received through the KPI system. According to an example embodiment, a KPI system 1200 can suggest to the Run Time user 1214 that the Run Time user enroll or subscribe to additional KPIs. KPIs can be suggested to the Run Time user by the central server based on the data available from different servers 1220 and 1224 that indicate involvement with different pools of data. Communications regarding subscription or unsubscription to a KPI and/or profile could be made through a user interface.

It should be appreciated that the present invention can be implemented in numerous ways, including as a process, an apparatus, a system, a computer processor executing software instructions, or a computer readable medium such as a non-transitory computer readable storage medium, or a computer Network wherein program instructions are sent over optical or electronic communication or non-transitory links. It should be noted that the order of the steps of disclosed processes can be altered within the scope of the invention, as noted in the appended claims and in the description herein.

Although the foregoing invention has been described in some detail for purposes of clarity of understanding, it will be apparent that certain changes and modifications can be practiced within the scope of the appended claims. The present invention can be practiced according to the claims and/or the embodiments without some or all of these specific details. Portions of the embodiments described herein can be used with or without each other and can be practiced in conjunction with a subset of all of the described embodiments. For the purpose of clarity, technical material that is known in the technical fields related to the invention has not been described in detail so that the present invention is not unnecessarily obscured.

It should be noted that there are many alternative ways of implementing both the process and apparatus of the present invention. Accordingly, the present embodiments are to be considered as illustrative and not restrictive, and the invention is not to be limited to the details given herein, but can be modified within the scope and equivalents of the appended claims.

What is claimed is:

1. A system for creating a profile to be applied in a run time environment, the system comprising:
at least one data hosting server including data related to a user and data related to one of a role or a task of the user in an organization;
a server that processes data related to a performance indicator of the organization, the server:
determining a user identification number of the user;
requesting data related to at least one of a personal role of the user and a business role of the user from the at least one data hosting server;
responsive to the request, receiving data related to at least one of the personal role of the user and the business role of the user from the at least one data hosting server;
generating a set of criteria related to at least one of the received personal role of the user and the business role of the user; and
formulating the set of criteria as a filter so that upon application of data having to do with the performance indicator to the filter, portions of the data related to the performance indicator but not including the set of criteria are filtered out.

2. The system as recited in claim 1, further comprising:
implementing the filter formulated by the server,
receiving as input the data having to do with the performance indicator,
applying the filter and filtering out the portions of the data related to the performance indicator but not including the set of criteria,
providing as output the filtered data; and
a user interface:
receiving the filtered data, and
displaying, for the user, the filtered data.

3. The system as recited in claim 1, further comprising:
a database associated with the server that stores the performance indicator and at least one additional performance indicator; and
a database associated with the at least one data hosting server.

4. The system as recited in claim 2, wherein the user, at the user interface, selects the performance indicator of the organization such that the selected performance indicator has respective data applied to the filter.

5. The system as recited in claim 2, the system further comprising:
a second filter, the second filter being formulated according to a second set of criteria related to at least one of a received personal role of a second user and a business role of the second user, such that formulating the second set of criteria upon application of data having to do with the performance indicator to the filter results in portion of the data related to the performance indicator but not including the second set of criteria being filtered out, and wherein the server:
implements the filter and the second filter,
receives as input the data having to do with the performance indicator,
determines which one of the filter and the second filter should be applied to the data having to do with the performance indicator,
applies the determined one of the filter and the second filter and filtering out the portions of the data related to the performance indicator but not including a respective one of the set of criteria and the second set of criteria, and
provides as output the filtered data.

6. A filter for applying a profile in a run time environment to data relating to a performance indicator, the filter comprising:
a first set of criteria related to a personal role of a user in an organization; and
a second set of criteria related to a business role of the user in the organization,
wherein the filter:
accepts as input data having to do with the performance indicator,
filters out data not meeting both the first set of criteria and the second set of criteria, and
provides as output filtered data having to do with the performance indicator to the user.

7. The filter as recited in claim 6, the filter further comprising:
a second filter, wherein the second filter:
accepts as input the output filtered data,
filters out data not meeting an additional set of criteria related to another aspect of a role of the user in the organization, and
provides as output twice filtered data having to do with the performance indicator to the user.

8. The filter as recited in claim 6, wherein the filter is a dashboard that includes:
multiple first sets of criteria related to a respective personal role of a respective user in an organization;
multiple second sets of criteria related to a respective business role of a respective user in the organization, each set of the multiple second sets of criteria being paired with a respective set from the multiple first sets of criteria,
wherein the dashboard:
accepts as input at least one set of data, each set of data having to do with a different performance indicator,
determines whether to apply data having to do with each of the performance indicators to each of the paired multiple first sets and multiple second sets of criteria,
applies each of the performance indicators to the paired multiple first sets and multiple second sets of criteria if the performance indicator is determined to be applicable to that set,
for each of the applied performance indicators:
filters out data not meeting both the first set of criteria and the second set of criteria, and
provides as output filtered data having to do with the performance indicator to the user.

9. The filter as recited in claim 6, wherein the first set of criteria related to the personal role of the user includes at least one of: an employee business location, an employee job title, an employee responsibility, and a language spoken at an employee business location.

10. The filter as recited in claim 6, wherein the second set of criteria related to the business role of the user includes at least one of: at least one project and at least one product, that involves the user.

11. A method for applying a performance indicator to a profile in order to filter data of the performance indicator so that displayed data is relevant to a runtime environment user:
identifying an identification number of the runtime environment user;
requesting, from a first external system, information regarding a personal role of the runtime environment user identified by the identification number;
receiving, from the first external system, the information regarding the personal role of the runtime environment user;
requesting, from a second external system, information regarding a business role of the runtime environment user identified by the identification number;
receiving, from the second external system, the information regarding the business role of the runtime environment user;
creating the profile by implementing a filter that filters input criteria according to whether it meets both a first set of criteria including the information regarding the personal role of the runtime environment user and a second set of criteria including the information regarding the business role of the runtime environment user;
applying as the input criteria to the filter data related to the performance indicator;
filtering out, by the filter, the input criteria according to whether or not it meets both the first set of criteria and the second set of criteria;
providing the filtered data to the runtime environment user as one of: raw data and a display of the filtered data according to the performance indicator.

12. The method as recited in claim 11, the method further comprising:
responsive to the identified identification number being one of: associated with a runtime environment user having a highest clearance level and preselected:
omitting creation of a respective profile, and
providing unfiltered data of the performance indicator to the runtime environment user.

13. The method as recited in claim 11, the method further comprising:
identifying, by the runtime environment user, at least one performance indicator to be applied as the input criteria.

14. The method as recited in claim 11, the method further comprising:
requesting, from a third external system, information regarding analytical privileges of the runtime environment user;
receiving, from the third external system, information regarding the analytical privileges of the runtime environment user;
creating the profile by implementing the filter that filters input criteria according to whether it meets all of a first set of criteria, a second set of criteria, and a third set of criteria including the information regarding the analytical privileges of the runtime environment user; and
filtering out, by the filter, the input criteria according to whether or not it meets all of the first set of criteria, the second set of criteria, and the third set of criteria,
wherein meeting the third set of criteria involves comparing a confidentiality level of the data related to the performance indicator to a confidentiality level of the runtime environment user.

15. The method as recited in claim 14, wherein:
if the confidentiality level of the data related to the performance indicator exceeds the confidentiality level of the runtime environment user, then the third set of criteria is not met, and
if the confidentiality level of the data related to the performance indicator is less than the confidentiality level of the runtime environment user, then the third set of criteria is met.

16. The method as recited in claim 11, wherein the runtime environment user can modify the profile by altering one of the first set of criteria and the second set of criteria in the filter.

17. The method as recited in claim 11, wherein the filtering out is performed by first the filter and then at least one additional filter cascaded after the filter in order to apply at least one additional set of criteria.

18. A non-transitory computer readable storage device storing program instructions that, when executed, cause a processing device to perform a method for applying a performance indicator to a profile in order to filter data of the performance indicator so that displayed data is relevant to a runtime environment user, the method comprising:
identifying an identification number of the runtime environment user;
requesting, from a first external system, information regarding a personal role of the runtime environment user identified by the identification number;
receiving, from the first external system, the information regarding the personal role of the runtime environment user;
requesting, from a second external system, information regarding a business role of the runtime environment user identified by the identification number;
receiving, from the second external system, the information regarding the business role of the runtime environment user;
creating the profile by implementing a filter that filters input criteria according to whether it meets both a first set of criteria including the information regarding the personal role of the runtime environment user and a second set of criteria including the information regarding the business role of the runtime environment user;
applying as the input criteria to the filter data related to the performance indicator;
filtering out, by the filter, the input criteria according to whether or not it meets both the first set of criteria and the second set of criteria;
providing the filtered data to the runtime environment user as one of: raw data and a display of the filtered data according to the performance indicator.

19. The non-transitory computer readable storage device as recited in claim 18, wherein the filtering out is performed by first the filter and then at least one additional filter cascaded after the filter in order to apply at least one additional set of criteria.

20. The non-transitory computer readable storage device as recited in claim 18, the method further comprising:
identifying, by the runtime environment user, at least one performance indicator to be applied as the input criteria.
